(19) United States
(12) Patent Application Publication
(10) Pub. No.: US 2026/0291244 A1
(43) Pub. Date: Sep. 24, 2026

(54) POWER SUPPLY SYSTEM

(71) Applicant: TOYOTA JIDOSHA KABUSHIKI KAISHA, Toyota-shi (JP)

(72) Inventors: Yuya MIYAZONO, Toyota-shi (JP); Hironaga Ono, Toyota-shi (JP); Ryohei Chino, Toyota-shi (JP)

(73) Assignee: TOYOTA JIDOSHA KABUSHIKI KAISHA, Toyota-shi (JP)

(21) Appl. No.: 19/335,827

(22) Filed: Sep. 22, 2025

(30) Foreign Application Priority Data
Oct. 15, 2024 (JP) 2024-180233

(51) Int. Cl. H02J 3/32; B60L 55/00

(52) U.S. Cl. CPC H02J 3/322; B60L 55/00

(57) ABSTRACT

A controller performs a process including: checking a vehicle power feeding voltage in response to a power feeding stop command during power feeding from a vehicle; maintaining the ON state of a second electromagnetic switch when the vehicle power feeding voltage is larger than a threshold value Va; and switching a first electromagnetic switch to the ON state and switching the second electromagnetic switch to the OFF state when the vehicle power feeding voltage is equal to or less than the threshold value Va.

### CROSS REFERENCE TO RELATED APPLICATIONS

This nonprovisional application is based on Japanese Patent Application No. 2024-180233 filed on Oct. 15, 2024 with the Japan Patent Office, the entire contents of which are hereby incorporated by reference.

### BACKGROUND

### Field

The present disclosure relates to a power supply system.

### Description of the Background Art

In a power supply system capable of supplying power from a system power supply to an electrical load of a house, power from a vehicle can be fed to the electrical load mainly in an emergency (e.g., when a power failure of the system power supply occurs or when the system power supply is under power). In addition, it has been proposed to feed power from a vehicle to an electrical load on a daily basis (e.g., in a time period in which a system power supply has a high electricity fee). Japanese Patent Laying-Open No. 2019-71721 discloses a power supply system capable of utilizing electric power stored in an electrically powered vehicle.

### SUMMARY

In the power supply system as described above, when electric power is being fed from the vehicle to the electrical load and the power feeding is hindered due to, for example, disconnection of a connector connecting the vehicle and the electrical load, the power feeding to the electrical load may be stopped and accordingly the power feeding may not be continued.

An object of the present disclosure is to provide a power supply system capable of continuing power feeding to an electrical load, even when power feeding from a vehicle is hindered.

A power supply system according to an aspect of the present disclosure is a power supply system that supplies AC power from a system power supply to an electrical load of a house. The power supply system includes: a vehicle in which a power storage device is mounted; a current circuit breaker that receives AC power to be supplied to the house from the system power supply, and interrupts the AC power at least when overcurrent occurs; a load circuit breaker that electrically disconnects the current circuit breaker and the electrical load from each other; a first switch that switches between electrical connection and disconnection between the current circuit breaker and the electrical load; a second switch that is provided on a power line branched from a power line between the first switch and the electrical load, and switches between electrical connection and disconnection between the electrical load and the vehicle; and a control device that controls operation of each of the first switch and the second switch. In response to receiving a power feeding stop command from the vehicle during power feeding from the vehicle, the control device switches a source of electric power to be supplied to the electrical load, from the vehicle to the system power supply when a power feeding voltage from the vehicle becomes equal to or less than a threshold value.

Thus, in response to receiving the power feeding stop command, the source of electric power to be supplied to the electrical load is switched from the vehicle to the system power supply when the power feeding voltage from the vehicle becomes equal to or less than a threshold value, and therefore, even when the connector is disconnected, for example, it is possible to continue power feeding to the electrical load.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an example of a configuration of a power supply system according to the present embodiment.

FIG. 2 is a flowchart showing an example of a control process of an electromagnetic switch.

FIG. 3 is a flowchart showing an example of a control process of the electromagnetic switch during power feeding.

FIG. 4 is a diagram illustrating an example of a configuration of a power supply system according to a modification.

FIG. 5 is a diagram illustrating another example of the configuration of the power supply system according to a modification.

FIG. 6 is a flowchart illustrating an example of a control process of an electromagnetic switch according to a modification.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

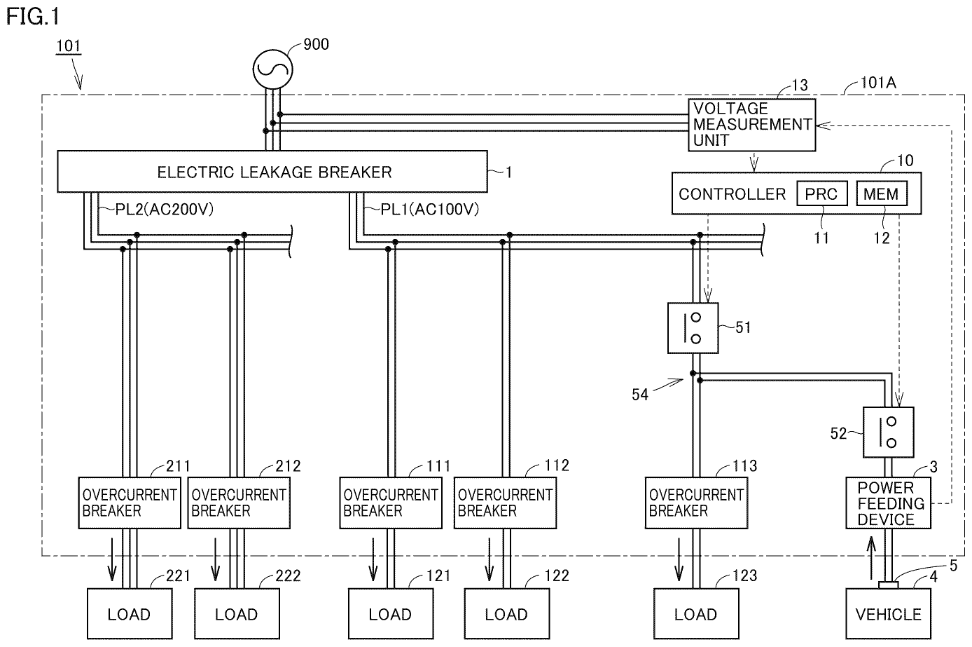

FIG. 1 is a diagram illustrating an example of a configuration of a power supply system according to the present embodiment. The power supply system 101 supplies power from a system power supply 900 to a load of a house 101A. The house 101A is typically a residential building such as a residential house. However, the house 101A may include a building that is not residential, a building that houses equipment, and the like. The load is various electric devices and is disposed inside (indoor) or outside (outdoor) the house 101A.

The power supply system 101 includes an electric leakage breaker (current circuit breaker) 1, an overcurrent breaker (load circuit breaker) 111-113, 211, 212, and a power feeding device 3. The number of overcurrent breakers is not particularly limited.

The electric leakage breaker 1 receives AC power to be supplied to the house 101A from the system power supply 900. The electric leakage breaker 1 is connected to an electric path (power line) PL1 for transmitting AC 100V AC power and an electric path PL2 for transmitting AC 200V AC power. The electric leakage breaker 1 electrically disconnects the system power supply 900 from the electric paths PL1 and PL2 at the time of electric leakage detection or overcurrent detection. The electric leakage breaker 1 corresponds to “current circuit breaker”. The electric leakage breaker 1 may be configured to cut off current when overcurrent is detected, and an overcurrent breaker may be used instead of the electric leakage breaker 1.

The overcurrent breakers 111 to 113 are electrically connected to the AC 100V electric path PL1. For example, the house 101A includes a plurality of rooms, and a load 121, a load 122, and a load 123 are provided for each room. The overcurrent breakers 111 to 113 are provided corresponding to the respective rooms of the house 101A. The overcurrent breakers 111 to 113 are configured to electrically disconnect the electric leakage breaker 1 from the loads 121 to 123 when overcurrent is detected. The overcurrent breaker 113 corresponds to “load circuit breaker”. Each load corresponds to “electrical load”.

The overcurrent breakers 211 and 212 are electrically connected to the AC 200V electric path PL2. The overcurrent breakers 211 and 212 are also provided for each room of the house 101A. The overcurrent breakers 211 and 212 are configured to electrically disconnect the electric leakage breaker 1 from the loads 221 and 222 when overcurrent is detected.

The power feeding device 3 is configured to be connected to the vehicle 4 via a power feeding cable and a connector 5. The vehicle 4 is an electrically powered vehicle equipped with a travel power storage device (battery) and capable of exchanging electric power with the outside of the vehicle, and is specifically a BEV (Battery Electric Vehicle) or PHEV (Plug-in Hybrid Electric Vehicle). The vehicle 4 further includes a power conversion device that converts DC power of the power storage device into AC power. The power feeding device 3 is configured to feed AC power from the vehicle 4 to a load (in this example, the load 123) when the vehicle 4 is connected or stop power feeding in response to a control command from the controller 10.

The power supply system 101 further includes a controller (control device) 10, a first electromagnetic switch (first switch) 51, and a second electromagnetic switch (second switch) 52.

The first electromagnetic switch 51 is configured to be capable of switching between electrical connection and disconnection between the electric leakage breaker 1 and the load 123. Specifically, the first end of the first electromagnetic switch 51 is electrically connected to the AC 100V electric path PL1. The second end of the first electromagnetic switch 51 is electrically connected to the overcurrent breaker 113. The first electromagnetic switch 51 is configured to switch between electrical connection and disconnection between the electric leakage breaker 1 and the overcurrent breaker 113 in accordance with a control command from the controller 10.

The second electromagnetic switch 52 is provided on a power line branched from the power line between the first electromagnetic switch 51 and the overcurrent breaker 113, and is configured to be capable of switching between electrical connection and disconnection between the load 123 and the vehicle 4. Specifically, the first end of the second electromagnetic switch 52 is electrically connected to the connection node 54 set between the second end of the first electromagnetic switch 51 and the overcurrent breaker 113. The second end of the second electromagnetic switch 52 is electrically connected to the power feeding device 3. Accordingly, the second electromagnetic switch 52 is configured to switch between electrical connection and disconnection between the connection node 54 and the power feeding device 3 in accordance with a control command from the controller 10. These two electromagnetic switches are also collectively referred to as “electromagnetic switches”.

The controller 10 is a computer device including a processor 11 and a memory 12, and is, for example, a HEMS (Home Energy Management System) controller. The controller 10 outputs a control command for opening and closing (switching on and off) each of the first electromagnetic switch 51 and the second electromagnetic switch 52. The controller 10 may be capable of acquiring power information (power transaction information, electricity fee information, and the like) of the system power supply 900 from an energy management server (not shown), opening and closing the first electromagnetic switch 51 and the second electromagnetic switch 52, and controlling the power feeding device 3 (that is, feeding power from the vehicle 4) according to the acquired power information. The controller 10 corresponds to “control device”.

For example, the voltage measurement unit 13 measures the voltage of the electric power transmitted and received between the system power supply 900 and the electric leakage breaker 1 and the voltage of the electric power transmitted and received between the vehicle 4 and the second electromagnetic switch 52 from the power feeding device 3, and transmits the measurement result to the controller 10. For example, the voltage measurement unit 13 measures a voltage and transmits an absolute value of the measured voltage to the controller 10 as a measurement result.

Since the AC power supplied from the system power supply 900 and the AC power fed from the vehicle 4 have different phases, which of the two AC powers is supplied to the loads 121 to 123 is selected by using the first electromagnetic switch 51 and the second electromagnetic switch 52.

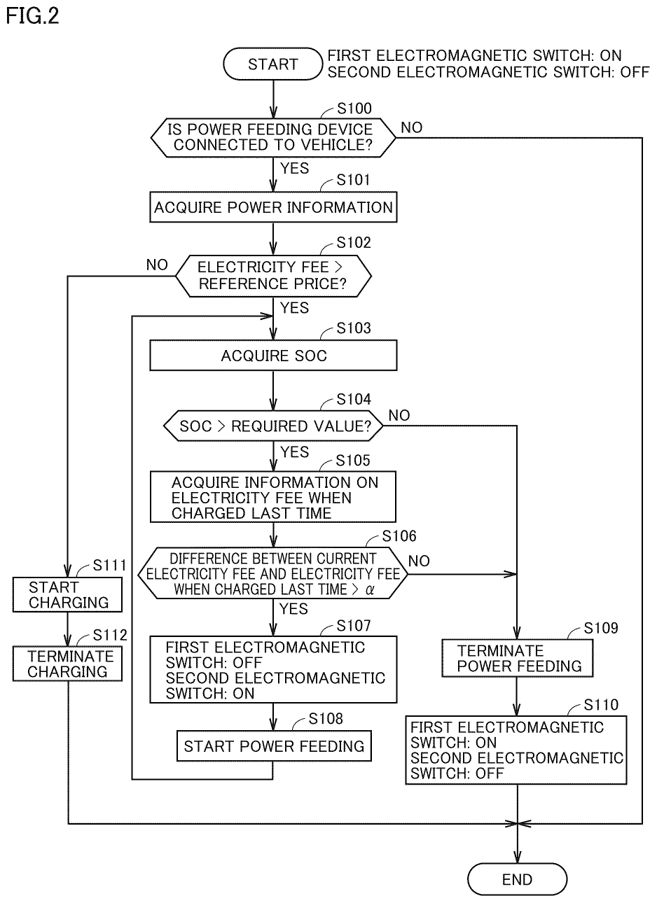

FIG. 2 is a flowchart showing an example of a control process of an electromagnetic switch. The process shown in FIG. 2 is executed when a predetermined condition is satisfied (for example, every predetermined cycle). Each step is implemented by software processing by the controller 10 (processor 11), but may be implemented by hardware (electrical circuit) disposed in the controller 10. It is assumed that the first electromagnetic switch 51 is turned on (closed) and the second electromagnetic switch 52 is turned off (opened) at the start of the series of processes.

In step (step is hereinafter referred to as S) 100, the controller 10 determines whether the power feeding device 3 is connected to the vehicle 4. When power feeding device 3 is connected to vehicle 4 (YES in S100), the process proceeds to S101. When power feeding device 3 is not connected to vehicle 4 (NO in S100), the process ends.

In S101, controller 10 acquires, for example, power information (current electricity fee information in this example) of system power supply 900 from the energy management server.

In S102, the controller 10 determines whether or not the current electricity fee acquired in S101 is higher than a reference price (for example, an average price of electricity fees of the day). When the current electricity fee is higher than the reference price (YES in S102), the process proceeds to S103.

In S103, the controller 10 acquires a state of charge (SOC) of a battery mounted on the vehicle 4 by communication with the vehicle 4 or the like. In addition, in the vehicle 4, the SOC is estimated by various known methods such as a method based on current value integration (coulomb count) or a method based on estimation of an open circuit voltage (OCV) using detected values of a current, a voltage, and a temperature of the battery, for example.

In S104, controller 10 determines whether or not the acquired SOC is higher than a required value. The required value is, for example, a value corresponding to the amount of electric power necessary for traveling of the vehicle 4 on the next day. The required value may be a predetermined fixed value or a variable value determined according to the actual use result of the vehicle 4. If the SOC is higher than the required value (YES in S104), the process proceeds to S105.

In S105, the controller 10 acquires, from the energy management server, the information on the electricity fee when the vehicle 4 was charged last time. Thereafter, the process proceeds to S106.

In S106, the controller 10 calculates a difference between the current electricity fee acquired in S101 and the electricity fee at the time of the preceding charging acquired in S105, and determines whether or not the difference is equal to or greater than a threshold value α. When the difference is larger than threshold value α (YES in S106), the process proceeds to S107. If the difference is equal to or less than the threshold value α (NO in S106), the process proceeds to S109. Although the threshold value α is a positive value in the present embodiment, the threshold value α may be 0. Further, in the present embodiment, an example in which the difference is calculated is shown, but instead of the difference, for example, it may be determined whether or not the ratio (b/a) between the electricity fee b at the time of charging and the current electricity fee a is equal to or more than a threshold value α. The threshold value α may be set, for example, so that the user can obtain revenue.

In addition, in S105, although the information of the electricity fee at the time of the preceding charging is acquired, for example, in a case where the electric power currently stored in the vehicle 4 is stored by a plurality of times of charging in the past, the information of the average value of the electricity fees in the plurality of times may be acquired.

In S107, the controller 10 turns off the first electromagnetic switch 51 and turns on the second electromagnetic switch 52. Thereafter, the process proceeds to S108.

In S108, the controller 10 controls the power feeding device 3 such that power feeding from the vehicle 4 to the load 123 is started. Thereafter, the process returns to S103. When the power feeding from the vehicle 4 is continued, the SOC decreases with the elapse of time. Therefore, when the SOC is equal to or less than the required value (NO in S104), the process proceeds to S109.

In S109, the controller 10 controls the power feeding device 3 to terminate the power feeding from the vehicle 4 to the load 123. Thereafter, the process proceeds to S110.

In S110, the controller 10 turns on the first electromagnetic switch 51 and turns off the second electromagnetic switch 52. Thereafter, the process ends. In the case where a charging device is further provided, when the electricity fee is equal to or lower than the reference price (NO in S102), the charging device may be controlled so that the power storage device mounted on vehicle 4 is charged (S111, S112).

In FIG. 2, an example in which the subsequent processing is changed depending on whether or not the electricity fee is higher than the reference price has been described. Instead, the controller 10 may switch the process depending on whether or not the current time is the nighttime time slot (time slot in which the nighttime fee is applied). This also saves electricity fees. Alternatively, the controller 10 may switch the process depending on whether or not the current time period is a time period in which the power demand of the house 101A reaches a peak. By feeding power from the vehicle 4 during the time period when the power demand reaches the peak, it is possible to cover the peak of the power demand even when the maximum supply current from the system power supply 900 is low, so that it is possible to reduce the so-called contract amperage. Therefore, the electricity fee can be saved.

In the power supply system 101 having the above-described configuration, for example, when the first electromagnetic switch 51 is in the OFF state and the second electromagnetic switch 52 is in the ON state, power is fed from the vehicle 4 to the load 123. At this time, when the connector 5 is removed from the inlet of the vehicle 4 or the like, the power feeding to the load 123 may be stopped and the power feeding may not be continued.

Therefore, in the present embodiment, when a power feeding stop command is received during power feeding from the vehicle 4, the controller 10 switches the power supply source to the load 123 from the vehicle 4 to the system power supply 900 when the power feeding voltage from the vehicle 4 becomes equal to or less than the threshold value.

In this way, when the power feeding stop command from the vehicle 4 is received by the controller 10 due to the connector 5 coming out of the inlet of the vehicle 4 or the like, the power supply source to the load 123 is switched from the vehicle 4 to the system power supply 900 when the power feeding voltage from the vehicle 4 becomes equal to or less than the threshold value, and thus the power feeding to the load 123 can be continued.

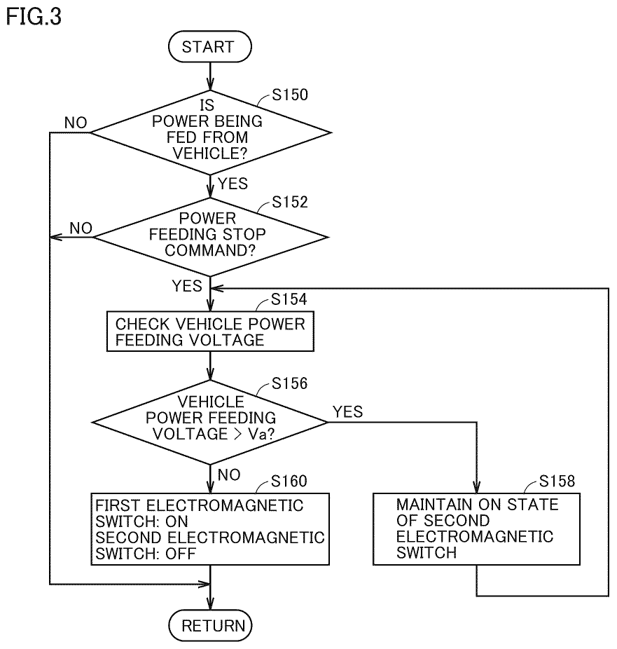

Hereinafter, with reference to FIG. 3, an example of a process of controlling the electromagnetic switch during power feeding, executed by the controller 10 in the present embodiment will be described. FIG. 3 is a flowchart showing an example of a control process of the electromagnetic switch during power feeding. The series of processes shown in this flowchart is repeatedly executed at predetermined intervals. Since it is assumed in the series of processes that power is being fed from the vehicle 4 to the load 123, it is assumed that the first electromagnetic switch 51 is turned off (opened) and the second electromagnetic switch 52 is turned on (closed).

In S150, the controller 10 determines whether or not power is being fed. For example, the controller 10 may determine whether or not power is being fed from the vehicle 4 to the load 123 using the measurement result from the voltage measurement unit 13. For example, the controller 10 may determine that power is being fed from the vehicle 4 to the load 123 when the measurement result (for example, voltage change) of the voltage measurement unit 13 indicates that power is not being transmitted from the electric leakage breaker 1 to the system power supply 900 (i.e., no current is flowing) and the measurement result indicates that power is being transmitted from the vehicle 4 to the second electromagnetic switch 52 (i.e., current is flowing). When it is determined that power is being fed (YES in S150), the process proceeds to S152.

In S152, the controller 10 determines whether or not there is a power feeding stop command. For example, when a power feeding stop command is received from the vehicle 4, the controller 10 determines that there is a power feeding stop command. In the vehicle 4, for example, during power feeding, when the connector 5 is removed from the inlet of the vehicle 4, the connector 5 is removed from the inlet of the vehicle 4, or the vehicle 4 receives an operation for stopping power feeding from a user of the vehicle 4, and the connector 5 is disconnected, a power feeding stop command is transmitted to the controller 10. The vehicle 4 (specifically, the control device of the vehicle) may determine that the connector 5 is removed from the inlet, for example, when a signal from a switch (not shown) that outputs an ON signal when the connector 5 is attached is switched to an OFF signal. When it is determined that there is a power feeding stop command (YES in S152), the process proceeds to S154.

In S154, the controller 10 checks the vehicle power feeding voltage. The controller 10 acquires the voltage fed from the vehicle 4 (vehicle power feeding voltage) using the measurement result from the voltage measurement unit 13. Thereafter, the process proceeds to S156.

In S156, the controller 10 determines whether or not the vehicle power feeding voltage is greater than threshold value Va. The threshold value Va may be any value as long as it can be determined that the power feeding is stopped, may be a predetermined value, and is not particularly limited, but may be zero, for example. When it is determined that the vehicle power feeding voltage is greater than threshold value Va (YES in S156), the process proceeds to S158.

In S158, the controller 10 maintains the ON state of the second electromagnetic switch 52. At this time, the controller 10 also maintains the OFF state of the first electromagnetic switch 51. Therefore, the power feeding from the vehicle 4 to the load 123 is continued. Thereafter, the process returns to S154. On the other hand, when it is determined that the vehicle power feeding voltage is equal to or lower than threshold value Va (NO in S156), the process proceeds to S160.

In S160, the controller 10 controls the first electromagnetic switch 51 and the second electromagnetic switch 52 such that the first electromagnetic switch 51 is turned on and the second electromagnetic switch 52 is turned off. Thereafter, the process ends.

The operation of the power supply system 101 according to the present embodiment based on the above-described structure and flowchart will be described. For example, it is assumed that the connector 5 is connected to the inlet of the vehicle 4, and power is supplied from the battery of the vehicle 4 to the load 123 via the power feeding device 3, the second electromagnetic switch 52, and the overcurrent breaker 113.

If it is determined that power is being fed (YES in S150), the controller 10 determines whether or not there is a power feeding stop command (S152). When the connector 5 attached to the inlet is removed, a power feeding stop command is output from the vehicle 4 to the controller 10. When there is a power feeding stop command (YES in S152), the vehicle power feeding voltage is acquired (S154). When it is determined that the acquired vehicle power feeding voltage is larger than threshold value Va (YES in S156), the ON state of second electromagnetic switch 52 is maintained (S158). On the other hand, when it is determined that the vehicle power feeding voltage is equal to or lower than the threshold value Va (NO in S156), the first electromagnetic switch 51 is switched from the OFF state to the ON state, and the second electromagnetic switch 52 is switched from the ON state to the OFF state (S160).

Therefore, AC power from the system power supply 900 is supplied to the load 123 via the electric leakage breaker 1, the first electromagnetic switch 51, and the overcurrent breaker 113. As a result, the power feeding to the load 123 is continued.

As described above, according to the power supply system 101 of the present embodiment, when the power feeding stop command from the vehicle 4 is received by the controller 10 due to the connector 5 coming out of the inlet of the vehicle 4 or the like, the power supply source to the load 123 is switched from the vehicle 4 to the system power supply 900 when the power feeding voltage from the vehicle 4 becomes equal to or lower than the threshold value, and thus the power feeding to the load 123 can be continued. Therefore, it is possible to provide a power supply system that prevents power feeding to an electrical load from being stopped even when power feeding from a vehicle is hindered.

Further, in the present embodiment, by using the first electromagnetic switch 51 and the second electromagnetic switch 52, it is possible to select which of the AC power from the system power supply 900 and the AC power from the vehicle 4 is supplied to the loads 121 to 123. More specifically, AC power from system power supply 900 is selected by turning on first electromagnetic switch 51 and turning off second electromagnetic switch 52. On the other hand, the AC power from the vehicle 4 is selected by turning off the first electromagnetic switch 51 and turning on the second electromagnetic switch 52. Therefore, according to the present embodiment, electric power from the vehicle 4 or electric power from the system power supply 900 can be selectively fed to the load 123 with a simple system configuration using two electromagnetic switches.

Hereinafter, modification examples will be described.

In the above-described embodiment, the vehicle 4 includes the power conversion device that converts the DC power of the power storage device of the vehicle 4 into the AC power, but the power feeding device 3 may convert the DC power of the power storage device of the vehicle 4 into the AC power.

Further, in the above-described embodiment, the configuration in which the first electromagnetic switch 51 is connected between the electric leakage breaker 1 and the overcurrent breaker 113 has been described as an example, but the present invention is not particularly limited to such a configuration. The first electromagnetic switch 51 may be connected between the overcurrent breaker 113 and the load 123, for example.

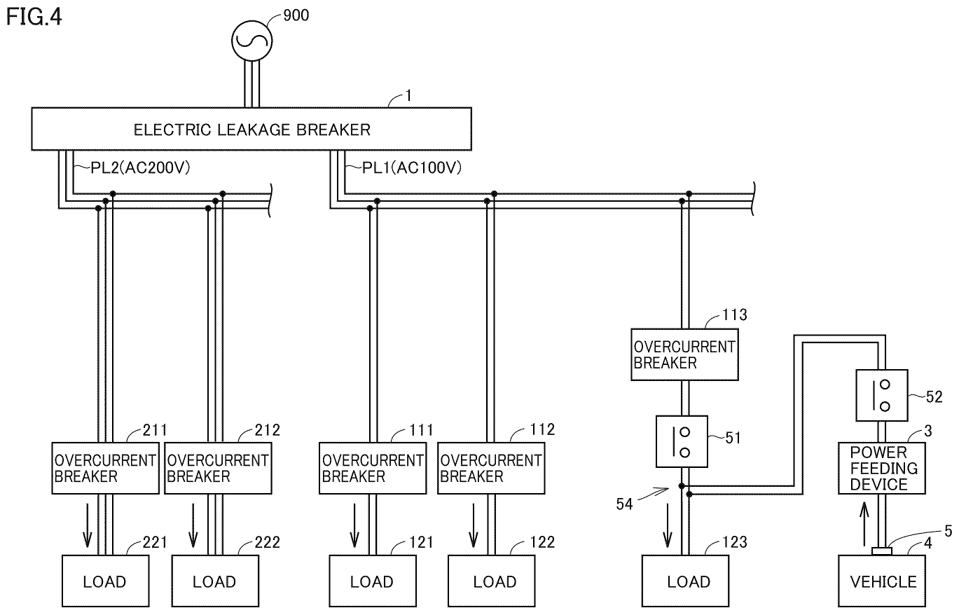

FIG. 4 is a diagram illustrating an example of a configuration of a power supply system 101 according to a modification. The configuration of the power supply system 101 illustrated in FIG. 4 is different from the configuration of the power supply system 101 illustrated in FIG. 1 in that the first electromagnetic switch 51 is provided between the overcurrent breaker 113 and the load 123 and that the first end of the second electromagnetic switch 52 is connected to the connection node 54 set between the first electromagnetic switch 51 and the load 123. Since other configurations are the same, detailed description thereof will not be repeated except for the case described below. As shown in FIG. 4, the first electromagnetic switch 51 may be provided between the overcurrent breaker 113 and the load 123. The first end of the first electromagnetic switch 51 is connected to the overcurrent breaker 113, and the second end of the second electromagnetic switch 52 is connected to the load 123. Further, the connection node 54 set between the second end of the first electromagnetic switch 51 and the load 123 may be connected to the first end of the second electromagnetic switch 52. Even in this case, when a power feeding stop command is received during power feeding from the vehicle 4, the power supply source to the load 123 is switched from the vehicle 4 to the system power supply 900 when the vehicle power feeding voltage becomes equal to or lower than the threshold value Va, so that power feeding to the load 123 can be continued.

Further, in the above-described embodiment, the power supply system 101 may further include, for example, a solar power generation device as a power source.

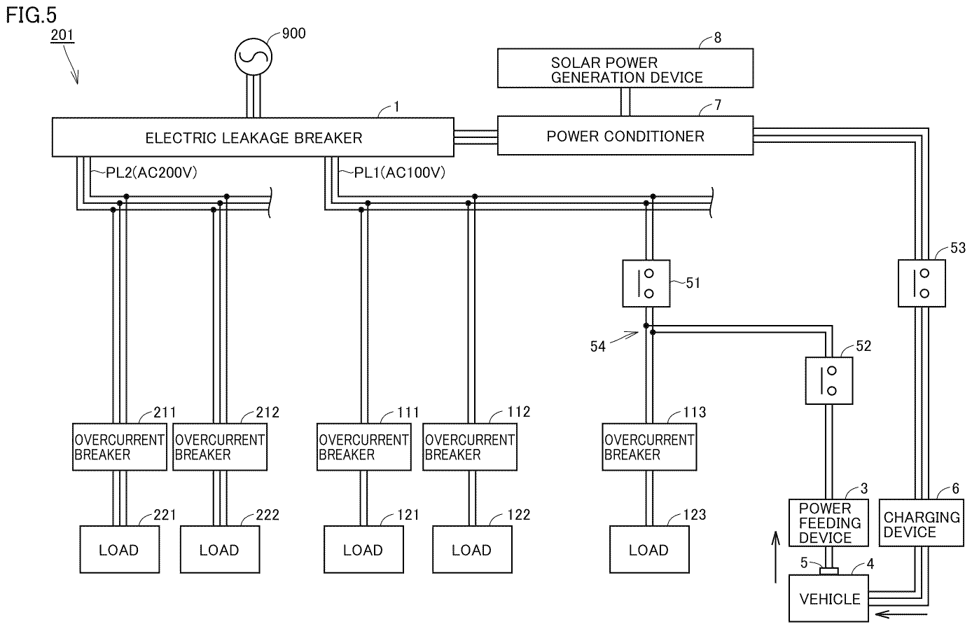

FIG. 5 is a diagram illustrating another example of the configuration of the power supply system 101 according to the modification. The power supply system 101 illustrated in FIG. 5 is different from the power supply system 101 illustrated in FIG. 1 in that it further includes a charging device 6, a power conditioner (PCS: Power Conditioning System) 7, a solar power generation device 8, and a third electromagnetic switch (third switch) 53. Since other configurations are the same as those of the power supply system 101 shown in FIG. 1 except for the case described below, detailed description thereof will not be repeated.

As shown in FIG. 5, the first end of the third electromagnetic switch 53 is electrically connected to the power conditioner 7. The second end of the third electromagnetic switch 53 is electrically connected to the charging device 6. The third electromagnetic switch 53 is configured to switch between electrical connection and disconnection between the power conditioner 7 and the charging device 6 in accordance with a control command from the controller 10.

The charging device 6 is configured to be connected to the vehicle 4 via a charging cable (may be shared with a power feeding cable) (not shown). The charging device 6 is configured to charge the vehicle 4 with AC power from the power conditioner 7 when the vehicle 4 is connected. The conversion from the AC power to the DC power may be performed in the charging device 6 or may be performed in the vehicle 4.

The power conditioner 7 receives DC power from the solar power generation device 8 and converts the DC power into AC power. The power conditioner 7 outputs AC power to the electric leakage breaker 1 and outputs the AC power to the charging device 6 via the third electromagnetic switch 53.

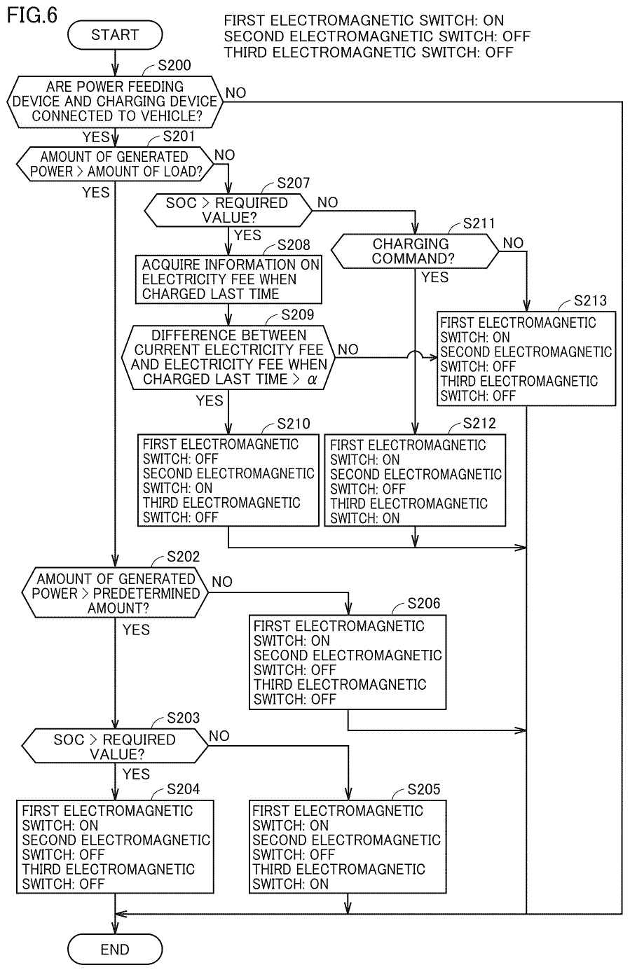

FIG. 6 is a flowchart illustrating an example of a control process of an electromagnetic switch according to a modification. At the start of the series of processes, it is assumed that the first electromagnetic switch 51 is turned on, the second electromagnetic switch 52 is turned off, and the third electromagnetic switch 53 is turned off.

In S200, the controller 10 determines whether the power feeding device 3 and the charging device 6 are connected to the vehicle 4. When the power feeding device 3 and the charging device 6 are connected to the vehicle 4 (YES in S200), the process proceeds to S201. When the power feeding device 3 and the charging device 6 are not connected to the vehicle 4 (NO in S200), the process ends. Note that the process of S200 may be omitted.

In S201, the controller 10 acquires information related to the generated power of the solar power generation device 8, and also acquires information related to the power consumption (load power) of each load in the house 101A. The controller 10 determines whether or not the generated power amount (the amount of generated power) within the specified time is larger than the load power amount (the amount of load) within the same specified time. When the amount of generated power is larger than the amount of load (YES in S201), the process proceeds to S202.

In S202, the controller 10 determines whether or not the amount of power generated by the solar power generation device 8 is greater than a predetermined amount. The predetermined amount is set to an amount of electric power sufficient to charge the vehicle 4. When the amount of generated power is larger than the predetermined amount (YES in S202), the process proceeds to S203.

In S203, the controller 10 determines whether the SOC of the vehicle 4 is higher than a required value. As described above, the required value may be set to a value corresponding to the amount of electric power necessary for the vehicle 4 to travel on the next day. In a case where the SOC is higher than the required value (YES in S203), that is, in a case where the amount of power generated by the solar power generation device 8 is sufficient to charge the vehicle 4, but the amount of power necessary for traveling is already stored in the vehicle 4, the process proceeds to S204.

In S204, the controller 10 turns on first electromagnetic switch 51, turns off second electromagnetic switch 52, and turns off third electromagnetic switch 53. Thereafter, the process ends. At this time, neither power feeding from the vehicle 4 nor charging of the vehicle 4 is performed. The AC power of the system power supply 900 or the generated power (electric power after AC conversion) of the solar power generation device 8 is supplied to the load 123. In a case where the SOC is equal to or less than the required value (NO in S203), that is, in a case where the amount of power generated by the solar power generation device 8 is sufficient to charge the vehicle 4 and the amount of power stored in the vehicle 4 is insufficient, the process proceeds to S205.

In S205, the controller 10 turns on the first electromagnetic switch 51, turns off the second electromagnetic switch 52, and turns on the third electromagnetic switch 53. Thereafter, the process ends. At this time, the vehicle 4 is charged by the power generated by the solar power generation device 8. The load 123 is supplied with the power of the system power supply 900 or the solar power generation device 8. When the amount of generated power of the solar power generation device 8 is equal to or less than the predetermined amount (NO in S202), that is, when the amount of generated power is larger than the amount of load but is not sufficient to charge vehicle 4, the process proceeds to S206.

In S206, the controller 10 turns on the first electromagnetic switch 51, turns off the second electromagnetic switch 52, and turns off the third electromagnetic switch 53 (S206). At this time, neither power feeding from the vehicle 4 nor charging of the vehicle 4 is performed. The AC power of the system power supply 900 or the generated power of the solar power generation device 8 is supplied to the load 123. When the amount of power generated by the solar power generation device 8 is equal to or less than the amount of load (NO in S201), that is, when only the solar power generation device 8 cannot satisfy the power demand of the house 101A, the process proceeds to S207.

In S207, the controller 10 determines whether or not the SOC of the vehicle 4 is higher than a required value. The required value may be the same as or different from the required value of S203. When the SOC is higher than the required value (YES in S207), that is, when the amount of electric power stored in the vehicle 4 is sufficient, the process proceeds to S208. If the SOC is equal to or lower than the required value (NO in S207), the process proceeds to S211.

In S208, the controller 10 acquires, for example, from the energy management server, information on the electricity fee at the time when vehicle 4 was charged last time. Thereafter, the process proceeds to S209.

In S209, the controller 10 calculates a difference between the current electricity fee and the electricity fee at the time of the preceding charging in which the information is acquired in S208, and determines whether or not the difference is equal to or greater than a threshold value α. When the difference is larger than threshold value α (YES in S209), the process proceeds to S210. If the difference is equal to or less than the threshold value α (NO in S209), the process proceeds to S213. In step S209, the same processing as in step S106 of FIG. 3 is performed, and thus detailed description thereof will be omitted.

In S210, the controller 10 turns off the first electromagnetic switch 51, turns on the second electromagnetic switch 52, and turns off the third electromagnetic switch 53. That is, power is fed from the vehicle 4 to the load 123 instead of from the system power supply 900. In a case where the SOC is equal to or less than the required value (NO in S207), that is, in a case where there is no margin enough to feed power to the outside in the amount of power stored in the vehicle 4, the process proceeds to S211.

In S211, the controller 10 determines whether or not there is an instruction to charge the vehicle 4 (S211). If there is a charge command (YES in S211), the process proceeds to S212.

In S212, the controller 10 turns on the first electromagnetic switch 51, turns off the second electromagnetic switch 52, and turns on the third electromagnetic switch 53. At this time, the vehicle 4 is charged by the power generated by the solar power generation device 8. The load 123 is supplied with AC power from the system power supply 900 or generated power of the solar power generation device 8. When there is no charge command (NO in S211), the process proceeds to S213.

In S213, the controller 10 turns on the first electromagnetic switch 51, turns off the second electromagnetic switch 52, and turns off the third electromagnetic switch 53 (S213). At this time, neither power feeding from the vehicle 4 nor charging of the vehicle 4 is performed.

In this modification, similarly to the above-described embodiment, the power supply system 101 includes the third electromagnetic switch 53 in addition to the first electromagnetic switch 51 and the second electromagnetic switch 52. As a result, it is possible to charge the vehicle 4 with the power generated by the solar power generation device 8 in addition to the power fed from the vehicle 4 with a simple system configuration in which only the third electromagnetic switch is added.

Further, in the above-described embodiment, the configuration in which the first electromagnetic switch 51 is provided between the electric path PL1 and the overcurrent breaker 113 has been described as an example, but may be provided at a position on the electric path PL1 closer to the electric leakage breaker 1 than the branch point to the overcurrent breaker 111.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power supply system that supplies AC power from a system power supply to an electrical load of a house, the power supply system comprising:
a vehicle in which a power storage device is mounted;
a current circuit breaker that receives AC power to be supplied to the house from the system power supply, and interrupts the AC power at least when overcurrent occurs;
a load circuit breaker that electrically disconnects the current circuit breaker and the electrical load from each other;
a first switch that switches between electrical connection and disconnection between the current circuit breaker and the electrical load;
a second switch that is provided on a power line branched from a power line between the first switch and the electrical load, and switches between electrical connection and disconnection between the electrical load and the vehicle; and
a control device that controls operation of each of the first switch and the second switch, wherein
in response to receiving a power feeding stop command from the vehicle during power feeding from the vehicle, the control device switches a source of electric power to be supplied to the electrical load, from the vehicle to the system power supply when a power feeding voltage from the vehicle becomes equal to or less than a threshold value.

2. The power supply system according to claim 1, wherein in at least one of: a case in which the vehicle and the second switch are disconnected from each other; and a case of receiving an operation for stopping the power feeding, the vehicle transmits the power feeding stop command to the control device.

3. The power supply system according to claim 1, wherein
in a case of supplying electric power from the system power supply to the electrical load, the control device closes the first switch and opens the second switch, and
in a case of feeding electric power from the vehicle to the electrical load, the control device opens the first switch and closes the second switch.

4. The power supply system according to claim 1, wherein
the house includes a power conditioner that receives electric power generated by a solar power generation device,
the power conditioner supplies AC power to the vehicle when being connected with the vehicle, and
the power supply system further comprises a third switch that switches between electrical connection and disconnection between the power conditioner and the vehicle.

5. The power supply system according to claim 4, wherein
in a case of feeding electric power from the vehicle, the control device opens the first switch, closes the second switch, and opens the third switch,
in a case of charging the vehicle, the control device closes the first switch, opens the second switch, and closes the third switch, and
in a case of not feeding electric power from the vehicle and not charging the vehicle, the control device closes the first switch, opens the second switch, and opens the third switch.

6. The power supply system according to claim 1, wherein in a case in which the vehicle and the second switch are connected to each other and a current electricity fee is higher than an electricity fee at a time of power feeding by electric power with which the vehicle is currently charged, the control device opens the first switch and closes the second switch.
